(19) United States
(12) Patent Application Publication
(10) Pub. No.: US 2007/0227649 A1
(43) Pub. Date: Oct. 4, 2007

(54) Method and device for forming external electrodes in electronic chip component

(75) Inventors: Ko Onodera, Tokyo (JP); Katsufumi Sato, Nikaho-shi (JP); Satoshi Kurimoto, Tokyo (JP); Yoji Tozawa, Tokyo (JP); Hiroshi Uemura, Tokyo (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/715,979

(22) Filed: Mar. 9, 2007

(30) Foreign Application Priority Data
Mar. 28, 2006 (JP) 2006-087758

(51) Int. Cl. B32B 37/12; B32B 38/00

(52) U.S. Cl. 156/230; 156/241; 156/278; 156/280; 156/538; 156/390

(57) ABSTRACT

A method and device for forming external electrodes on opposing surfaces of an electronic chip. A plurality of chips are arrayed on a plate and held at a first end faces by a silicon rubber provided on the plate. The plate is brought close to a coating bed so that second end faces of the chips are immersed in an electrically conductive paste formed on the coating bed. The second end faces of the chips are coated with the conductive paste which forms first electrodes after drying step. Subsequently, the plate is inverted and brought toward a sheet with a foamable and releasable adhesive layer for allowing the chips to be pressed against the foamable and releasable adhesive and held thereby. The chips are transferred from the plate to the sheet. Next, second electrodes are formed on the first end faces. After the first and second end faces are formed with electrodes, the sheet is heated, causing the foamable and releasable adhesive in the sheet to foam and lose its adhesive strength to remove the components from the sheet by their own weight.

### BACKGROUND OF THE INVENTION

The present invention relates to a method and device for forming external electrodes in an electronic chip component.

An electronic chip component, such as a ceramic stacked capacitor is well known in the art. One such electronic chip component has a main body with two opposing ends. External electrodes are formed on the opposing ends of the main body. These external electrodes can be formed by applying an electrically conductive paste to the ends of the main body and subsequently drying the paste.

In one conventional method for forming external electrodes in such an electronic chip component, one end of an electronic component is adhesively held by a first adhesive member having a through-hole formed therein, while forming a first external electrode on the other end of the electronic component. Subsequently, the first external electrode side of the electronic component is placed in contact with a second adhesive member having a through-hole formed therein. In this state, a pressing member is inserted into the through-hole of the first adhesive member for pressing the electronic component toward the second adhesive member side. Consequently, the electronic component is separated from the first adhesive member and held by the second adhesive member. While the other end of the electronic component is held by the second adhesive member, a second external electrode is formed on the first end.

Further, a negative pressure is applied in the through-hole of the first or second adhesive member when the electronic component is held by the same to increase the holding power of the adhesive member. Accordingly, after the second electrode has been formed, a positive pressure is applied through the through-hole formed in the second adhesive member to reduce the holding power of the adhesive member, thereby separating the electronic component from the second adhesive member. If separation is not easily attained, a pressing member can be inserted into the through-hole in the second adhesive member to apply force to the electronic component. Alternatively, a scraping jig can be used to peel off the adhesive member. Silicon rubber or the like is used as an adhesive material. The above method is disclosed in Japanese patent application publication No. 2001-118755.

In the method described above, it is necessary to peel the electronic component from the second adhesive member after completing formation of the external electrodes by applying an external force to the electronic component or scraping the adhesive from the electronic component with a jig. As a result, a portion of the second adhesive member or a portion of the electrode fixed to the second adhesive member may break, rendering the adhesive member unusable or causing damage to the electronic component. Further, broken remnants of the electrode remaining in the second adhesive member may reduce the adhesive strength of the adhesive member, requiring cleaning or other processing that could interfere with operations.

### SUMMARY OF THE INVENTION

In view of the foregoing, it is an object of the present invention to provide a method and device for forming external electrodes in an electronic chip component, the method and device being capable of separating the electronic component from the adhesive member without applying an external mechanical force, thereby enhancing productivity and ensuring sufficient production yield, while achieving a highly stable product quality.

This and other objects of the present invention will be attained by a method for forming external electrodes on a chip element having a first end face and a second end face on opposing ends to produce an electronic chip component, the method including a first fixing step, a first electrode applying step, a first drying step, a second fixing step, a second electrode applying step, a second drying step, and a separating step. The first fixing step is adapted for fixing the first end face to a first adhesive member. The first electrode applying step is adapted for applying an electrode material to the second end face of while the chip element is fixed to the first adhesive member. The first drying step is adapted for drying the electrode material applied in the first electrode applying step to produce a first external electrode. The second fixing step is adapted for transferring the chip element from the first adhesive member to a second adhesive member and fixing the first external electrode side of the chip element to the second adhesive member. The second electrode applying step is adapted for applying an electrode material to the first end face while the chip element is fixed to the second adhesive member. The second drying step is adapted for drying the electrode material applied in the second electrode applying step to produce a second external electrode. The separating step is adapted for separating the chip element from the second adhesive member without application of external mechanical force to the chip element.

In another aspect of the invention, there is provided a device for forming external electrodes on a chip element having a first end face and a second end face on opposing ends to produce an electronic chip component. The device includes a first conveying unit, a first fixing unit, a first electrode applying unit, a first drying unit, a second conveying unit, a second fixing unit, a second electrode applying unit, a second drying unit, and a separating unit. The first conveying unit is provided with a first adhesive member. The first fixing unit is configured to fix the first end face to the first adhesive member. The first electrode applying unit is configured to apply an electrode material onto the second end face while the first end face is fixed to the first adhesive member. The first drying unit is configured to dry the electrode material formed on the second end face to produce a first external electrode. The second conveying unit is provided with a second adhesive member. The second fixing unit is configured to transfer the chip elements from the first adhesive member to the second adhesive member and fix the first external electrode side of the chip element to the second adhesive member. The second electrode applying unit is configured to apply an electrode material to the first end face while the chip element is fixed to the second adhesive member. The second drying unit is configured to dry the electrode material applied in the second electrode to produce a second external electrode. The separating unit is configured to separate the chip element from the second adhesive member without application of external mechanical force to the chip element.

### BRIEF DESCRIPTION OF THE DRAWINGS

In the drawings:

FIG. 1 is an explanatory diagram illustrating a device for forming an external electrode for electronic chip components according to a first embodiment of the present invention;

FIG. 2 is a flowchart illustrating steps in a method for forming external electrodes according to the first embodiment;

FIG. 3 is a cross-sectional view showing chips disposed in an alignment block of the external electrode forming device of the first embodiment;

FIG. 4 is a plan view of the alignment block;

FIG. 5(a) through 5(c) are cross-sectional views illustrating a step for supplying and fixing a chip in the method of forming external electrodes, and FIG. 5(a) shows a state where a plate held parallel to a bed is brought near the same;

FIG. 5(b) shows a state where a silicon rubber is pressed against a first end face of a chip;

FIG. 5(c) shows a state where the chip and the plate are separated relative to the bed;

FIG. 6(a) through 6(c) are explanatory diagrams illustrating a step for applying a first electrode in the method of forming external electrodes and FIG. 6(a) shows a state where the chip held on the plate is brought relatively near an electrically conductive paste;

FIG. 6(b) shows a state where a second end face is immersed into the electrically conductive paste;

FIG. 6(c) shows a state where the chip is removed from the electrically conductive paste;

FIG. 7 is an explanatory diagram illustrating a radiation drying method employed in the method of forming external electrodes according to the first embodiment;

FIG. 8 is an explanatory diagram illustrating a convection drying method employed in the method of forming external electrodes according to the first embodiment;

FIG. 9(a) through 9(c) are explanatory diagrams illustrating a chip transfer step in the method of forming external electrodes, and FIG. 9(a) shows a state where a sheet and the plate holding the chip are brought into relative proximity of each other;

FIG. 9(b) shows a state where the chip is pressed against the sheet;

FIG. 9(c) shows a state where the plate and the sheet are relatively moved away from each other;

FIG. 10 is a flowchart illustrating steps in the chip transfer step according to the first embodiment;

FIG. 11 is an explanatory diagram illustrating the chip transfer step according to the first embodiment;

FIG. 12(a) through 12(c) are explanatory diagrams illustrating a step for applying a second electrode in the method of forming external electrodes, and FIG. 12(a) shows a state where the chip held by the sheet and a coating bed are brought toward each other;

FIG. 12(b) shows a state where the chip is pressed against the coating bed;

FIG. 12(c) shows a state where a second electrode is formed on the chip;

FIG. 13 is an explanatory diagram illustrating a chip discharge step in the method of forming external electrodes according to the first embodiment;

FIG. 14 is an explanatory diagram illustrating the foaming state of thermally foamable and releasable adhesive in the method of forming external electrodes according to the first embodiment;

FIG. 15 is an explanatory diagram illustrating the chip transfer method in the method of forming external electrodes according to a modification to the first embodiment; and,

FIG. 16 is an explanatory diagram showing a device of an external electrode forming device according to a second embodiment of the present invention.

### DETAILED DESCRIPTION OF THE PREFERRED EMBODIMENTS

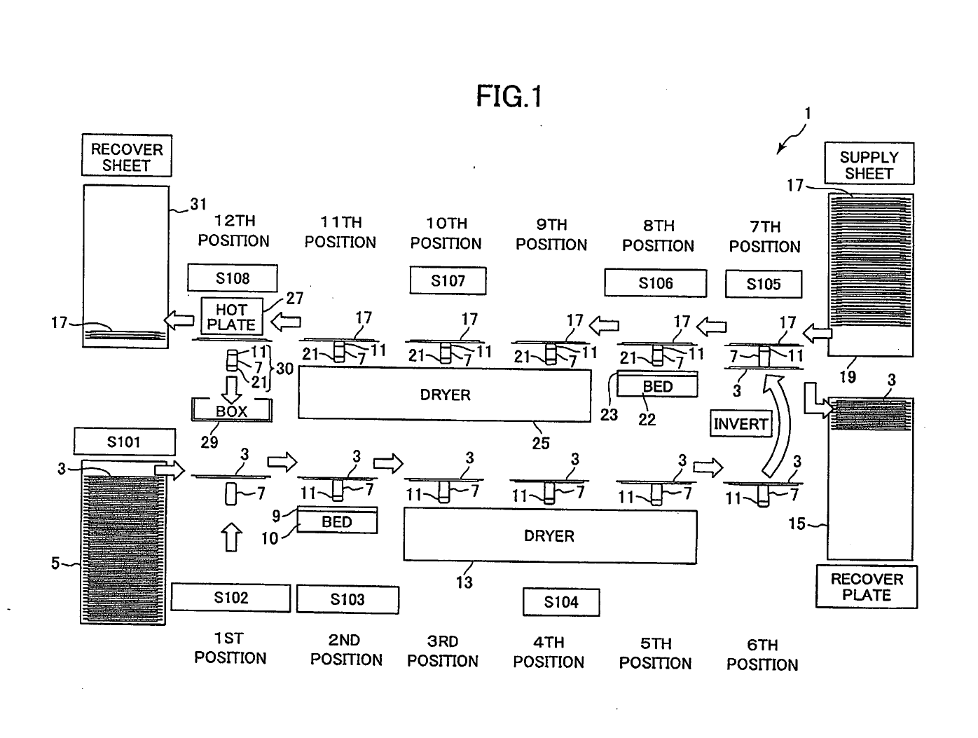

Next, preferred embodiments of the present invention will be described while referring to the accompanying drawings. FIGS. 1 through 14 illustrate a method and device for forming external electrodes in an electronic chip component according to a first embodiment of the present invention.

The method and device according to the first embodiment are configured to form external electrodes on opposing end faces of an electronic chip component, such as a ceramic stacked capacitor. FIG. 1 shows a device of an external electrode forming device 1 for forming electrodes in an electronic chip component. Chips 7 are chip elements prior to undergoing the electrode forming step. The chips 7 have a substantially rectangular parallelepiped shape with mutually opposing first and second end faces 7a and 7b. According to the method of the preferred embodiment, a first electrode 11 is formed on the second end face 7b, and a second electrode 21 is formed on the first end face 7a.

As shown in FIG. 1, the external electrode forming device 1 includes a plate supplying magazine 5, a coating bed 10, a dryer 13, a plate recovering magazine 15, a sheet supplying magazine 19, a coating bed 22, a dryer 25, a heater (hot plate) 27, a discharge box 29, and a sheet recovering magazine 31. The external electrode forming device 1 produces electronic chip components 30 (hereinafter simply referred to as “electronic components 30”) by forming external electrodes on chips 7 supplied into the external electrode forming device 1 through a sequence of prescribed steps.

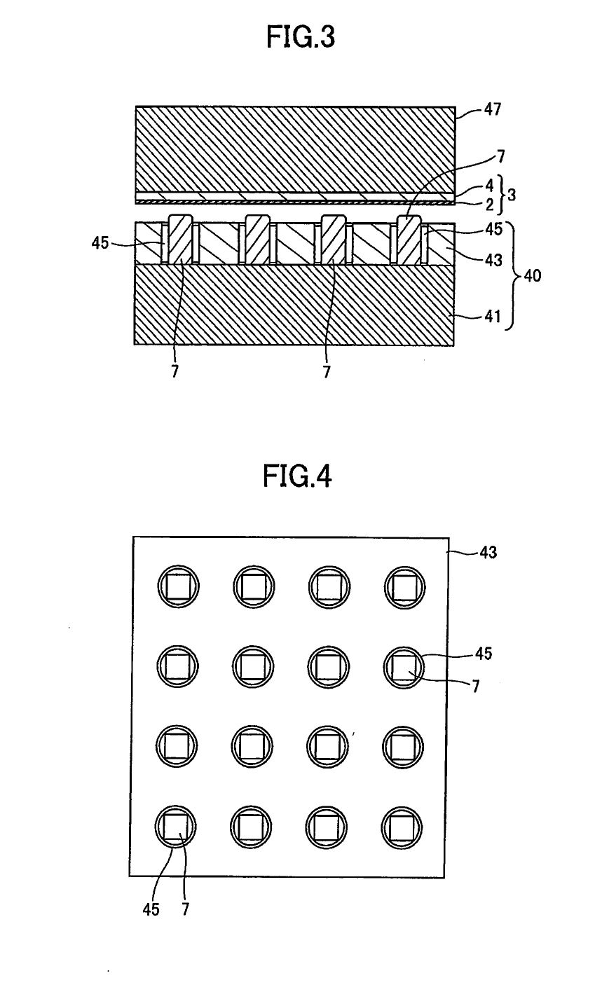

The plate supplying magazine 5 is a substantially rectangular parallelepiped container that accommodates a plurality of plates 3 in a stacked configuration. The plates 3 are substantially rectangular and plate-shaped and function as a first adhesive member with an adhesive silicon rubber as an adhesive. As is illustrated in greater detail in FIG. 3, the plate 3 is plate-shaped and rectangular in a plan view and includes a base plate 4 formed of a stainless steel and a silicon rubber 2 having an adhesive property formed on the surface of the base plate 4. A first conveyor (not shown) is adapted for supplying the plates 3 one at a time from the plate supplying magazine 5 to a first position (see FIG. 1) in the external electrode forming device 1 for beginning the electrode forming step. The plates 3 are supplied at predetermined intervals accounting for the time required for each step.

The coating bed 10 is positioned in a second position. In a plan view, the coating bed 10 has a shape similar to the plate 3. The surface of the coating bed 10 is formed with a high degree of flatness, and a layer of conductive paste 9 is provided on the surface of the coating bed 10 at a prescribed thickness. The plate 3 holding the chip 7 is brought relatively near the surface of the conductive paste 9 formed on the coating bed 10 so that the surfaces of the plate 3 and conductive paste 9 are parallel to each other, and the chip 7 is pressed against the coating bed 10, thereby immersing a prescribed portion of the second end face 7b side of the chip 7 in the conductive paste 9 and coating the second end face 7b side with the conductive paste. The dryer 13 such as a halogen heater and an ambient heater is disposed downstream of the coating bed 10 (in third through fifth positions) for drying the conductive paste coating the chip 7 to produce the first electrode 11 thereon. The plate recovering magazine 15 is a container having a substantially rectangular parallelepiped shape for accommodating the plates 3 in a stacked configuration. The plate recovering magazine 15 recovers the plates 3 after the chip 7 with the first electrode 11 formed thereon is separated from the plate 3.

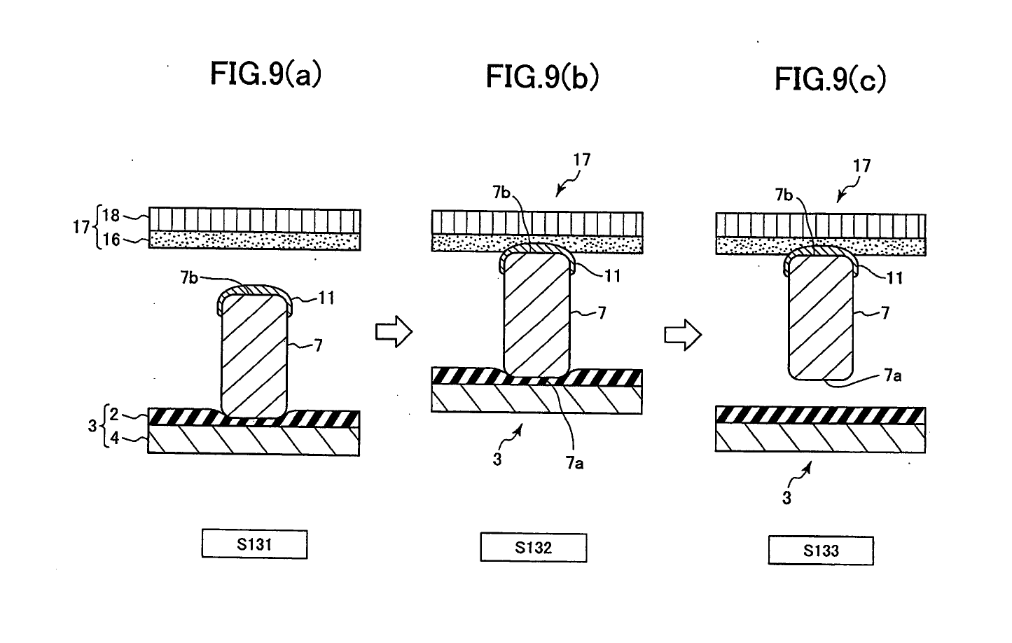

The sheet supplying magazine 19 is a substantially rectangular parallelepiped shaped container for accommodating a plurality of sheets 17 in a stacked configuration. Each sheet 17 has a second adhesive material layer made from a thermally foamable and releasable adhesive. As shown in greater detail in FIGS. 9 and 11, the sheet 17 is a substantially rectangular flat sheet configured of a polyethylene terephthalate (PET) base film 18 coated with a foamable and releasable adhesive 16. A second conveyor (not shown) is adapted for supplying the sheets 17, such that the surface coated with the foamable and releasable adhesive 16 faces downward, one at a time from the plate recovering magazine 15 to a seventh position in the external electrode forming device 1 for performing the electrode forming step. The sheets 17 are supplied at prescribed intervals based on the time required for each process.

The thermally foamable and releasable adhesive provided in the sheet 17 is also referred to as a thermal release adhesive. At room temperature, the adhesive demonstrates a normal adhesive strength, but when heated to a prescribed temperature or greater, the adhesive begins to foam, reducing the fixing surface area. Consequently, the adhesive loses its adhesive strength, releasing the object fixed by the adhesive. The adhesive strength and foaming temperature of this thermal foamable and releasable adhesive can be adjusted. In the preferred embodiment, the adhesive strength of this adhesive is set higher than that of the silicon rubber 2, and the foaming temperature is set lower than the upper temperature limit of the silicon rubber 2 that can maintains adhesivity thereof. The sheet 17 may be a thermal release tape, such as a product “REVALPHA” manufactured by Nitto Denko Corporation.

The coating bed is disposed at an eighth position. In a plan view, the coating bed 22 has substantially the same shape as the sheet 17. The surface of the coating bed 22 has a high degree of flatness, and a layer of an electrically conductive paste 23 is formed on the surface at a prescribed thickness. The sheet 17 holding the chip 7 is brought relatively near the surface of the conductive paste 23 formed on the coating bed 22 so that the surfaces of the sheet 17 and the conductive paste 23 are substantially parallel to each other. The chips 7 are pressed against the coating bed 22 so that a prescribed portion of a first end faces 7a of the chips 7 are immersed in the conductive paste 23, coating the first end faces 7a with the conductive paste. The dryer 25 is disposed downstream of the coating bed 22 at ninth through eleventh positions. The dryer 25 such as a halogen heater and an ambient heater is adapted for drying the conductive paste coating the chips 7 to produce the second electrodes 21.

The hot plate 27 is disposed downstream of the dryer 25 at a twelfth position in order to release the electronic components 30 from the sheet 17 after forming the electrodes. The hot plate 27 is adapted for heating the foamable adhesive in the sheet 17. The discharge box 29 is disposed below the hot plate 27. When heated, the sheet 17 loses its adhesive strength, and the electronic components 30 fall by their own weight and are collected in the discharge box 29. The sheet recovering magazine 31 is a substantially rectangular parallelepiped container for accommodating the sheets 17 in a stacked configuration. The magazine 31 thus recovers the sheet 17 after the electronic components 30 have separated therefrom.

While not shown in the drawings, the external electrode forming device 1 also includes the first conveyor for conveying the plates 3 intermittently and at prescribed intervals to each processing position, the second conveyor for conveying the sheets 17 intermittently and at prescribed intervals to each processing position, a mechanism for arranging a prescribed number of the chips 7 at prescribed positions on the plate 3 or sheet 17, a mechanism(s) for immersing the chips 7 held by the plate 3 or sheet 17 in the conductive paste 9 or conductive paste 23, and a mechanism(s) for conveying each the plate 3 and sheet 17 to the magazine 5 and 19.

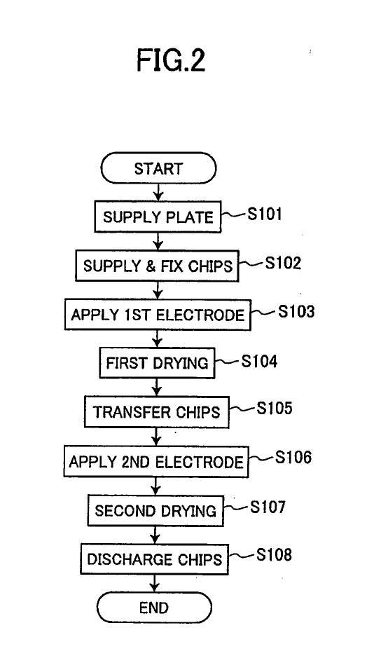

Next, a method of forming external electrodes according to the external electrode forming device 1 described above will be described. FIG. 2 is a flowchart illustrating steps in the external electrode forming method. In S101 of FIG. 2, the first conveyor supplies the plate 3 to the first position (see FIG. 1) in the external electrode forming device 1. The first conveyor supplies the plate 3 from the plate supplying magazine 5 to be held by a holder 47 (see FIG. 3). At this time, the plate 3 should be oriented with the silicon rubber 2 facing downward.

In S102 the chips 7 are supplied and fixed to the plate 3 disposed in the first position. As shown in FIGS. 3 through 5(c), an alignment block 40 is provided at this time. The alignment block 40 includes a plate-shaped bed 41 that is rectangular in shape and has a high degree of flatness, and a guiding plate 43 formed of silicon rubber, for example, and provided on the bed 41 for aligning the chips. A plurality of cylindrical openings 45 is formed in the guiding plate 43. In the embodiment of FIG. 4, sixteen openings 45 are formed in a single guiding plate 43 in a two-dimensional arrangement. Each opening 45 has an inner diameter larger than the maximum diameter of the first end face 7a and second end face 7b on each chip 7. The dimensions of the opening 45 should be such that there is sufficient gap between the chip 7 and inner peripheral walls 45a of the opening 45 to insert the chip 7 in or remove the chip 7 from the opening 45 without resistance.

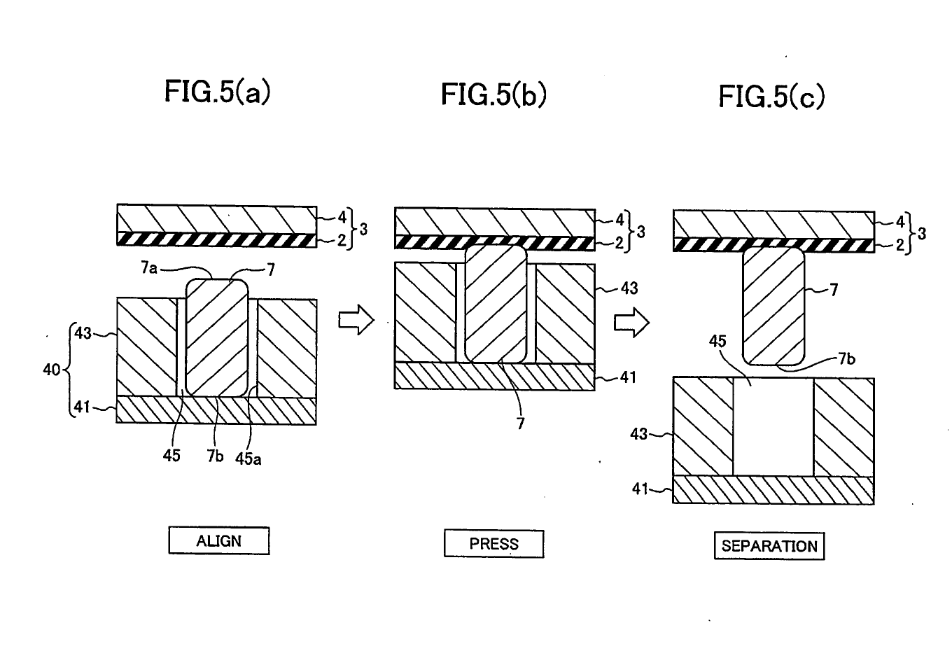

As shown in FIGS. 4 and 5(a), the chips 7 are slidingly inserted along the side walls 45a into the openings 45 until all sixteen of the openings 45 accommodate respective chips 7. Subsequently, as shown in FIGS. 3 and 5(a), the plate 3 held parallel to the bed 41 is brought near the same, and the silicon rubber 2 is pressed against the first end faces 7a of the chips 7 as shown in FIG. 5(b). Once the silicon rubber 2 holds the first end faces 7a of the chips 7, the plate 3 is separated relative to the bed 41, as shown in FIG. 5(c).

At this time, the chips 7 are held on the plate 3 through the adhesive strength of the silicon rubber 2. Hence, sixteen chips 7 are held on the plate 3 in a two-dimensional arrangement. Since the first end face 7a is substantially flat, all of the chips 7 have substantially the same size, and the surface of the bed 41 has a high degree of flatness, the first end faces 7a formed on all sixteen chips 7 arranged on the bed 41 are disposed in substantially the same plane. In this embodiment, the bed 41 is fixed while the plate 3 is movable toward and away from the bed 41 maintaining parallelism to the bed 41. Therefore, all of the chips 7 are pressed against the silicon rubber 2 with a substantially uniform pressure. Consequently, the chips 7 are fixed to the silicon rubber 2 such that the second end faces 7b on all sixteen chips 7 can be aligned in substantially the same plane. Incidentally, FIGS. 1, 5, and the like show the state of only one chip 7 for the purpose of simplicity.

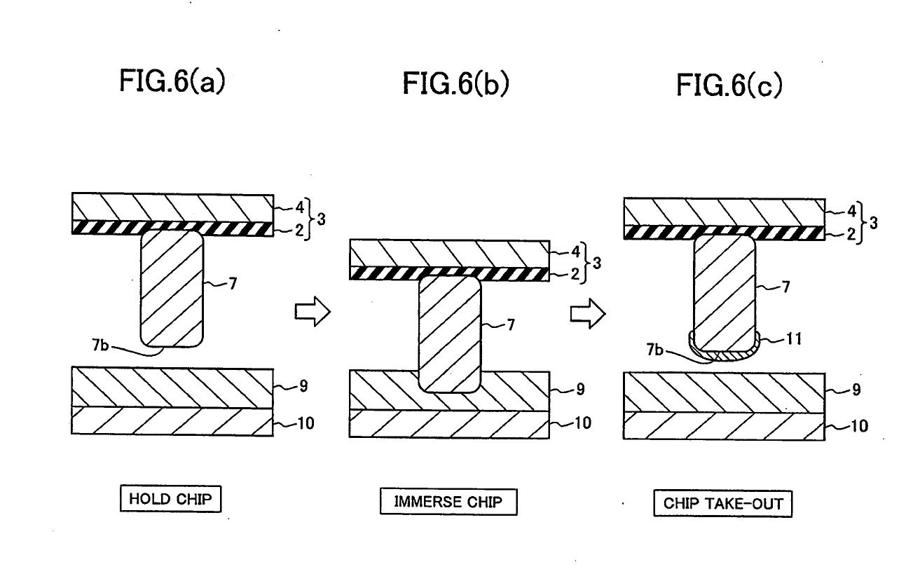

In S103, the first electrode 11 is coated on the second end face 7b of the chip 7. For this process, the plate 3 holding the chips 7 is conveyed to the second position shown in FIG. 1 so that the coating bed 10 is disposed directly beneath the chips 7. As shown in FIG. 6(a), the chips 7 held on the plate 3 are brought relatively near the electrically conductive paste 9, and the second end faces 7b of the chips 7 are pressed against the coating bed 10, immersing the chips 7 into the conductive paste 9 by a prescribed depth on the second end face 7b side as shown in FIG. 6(b). Subsequently, the plate 3 is separated relative to the coating bed 10, removing the chips 7 from the conductive paste 9 and leaving a coating of the electrode paste as the first electrodes 11 as shown in FIG. 6(c). Since the second end faces 7b of all chips 7 held by the plate 3 are provided in substantially the same plane, as described above, all of the chips 7 are immersed in the electrically conductive paste 9 to substantially the same depth, thereby coating the second end faces 7b of the chips 7 with substantially the same degree of electrically conductive paste.

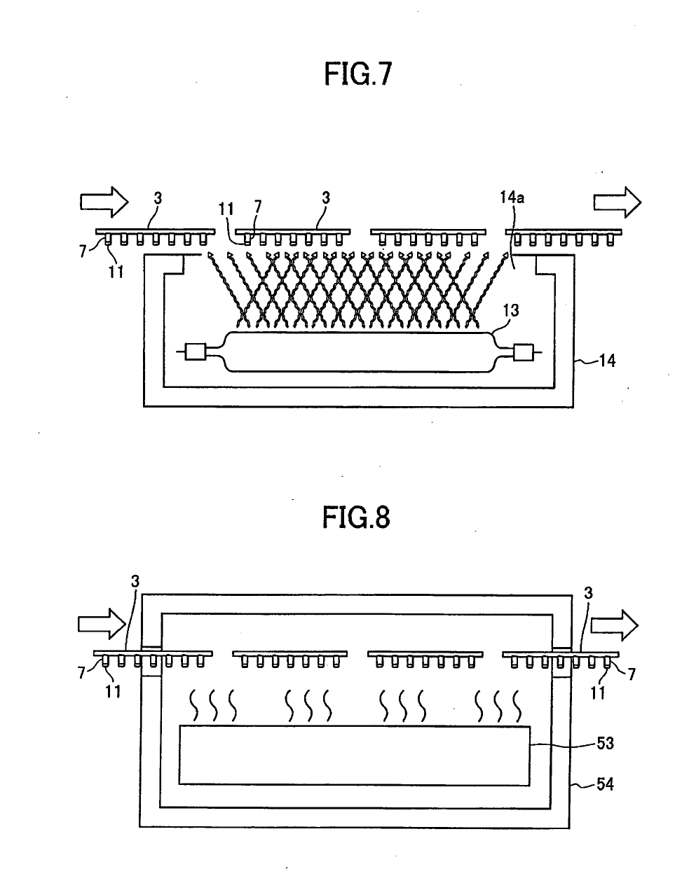

In S104 the coating of conductive paste forming the first electrodes 11 is dried. This first drying step is performed while conveying the plate 3 from the third position to the fifth position. As shown in FIG. 1, the conductive paste is dried through direct heat produced by the halogen heater or through ambient heat. In case of direct heating, the dryer 13 is disposed in a drying furnace 14, as shown in FIG. 7. Light emitted from the heater (halogen lamp) 13 is converted to far-infrared rays through a special filter for drying the conductive paste by radiation. An opening 14a is formed in the side of the drying furnace 14 facing the chips 7, and the plate 3 holding the chips 7 is positioned outside of the opening 14a. The halogen lamp—(dryer) 13 is disposed near the bottom surface of the drying furnace 14 opposite the opening 14a and is elongated in the direction that the chips 7 are conveyed. The structure of the dryer 13 and drying furnace 14 is configured to maintain a uniform heating temperature, while ensuring that the chips 7 are exposed to the heat for a prescribed time.

In case of ambient heating, a heater 53 is disposed in a drying furnace 54, as shown in FIG. 8. The drying furnace 54 only has openings for the entry and exit of the plate 3 holding the chips 7. The heater 53 increases the temperature within the drying furnace 54 and dries the conductive paste through heat convection.

In either drying method, the temperature should be slightly under 200° C., for example. Further, in either drying method, the chips 7 are held by the plate 3 and moved intermittently at prescribed intervals from the third position to the fifth position.

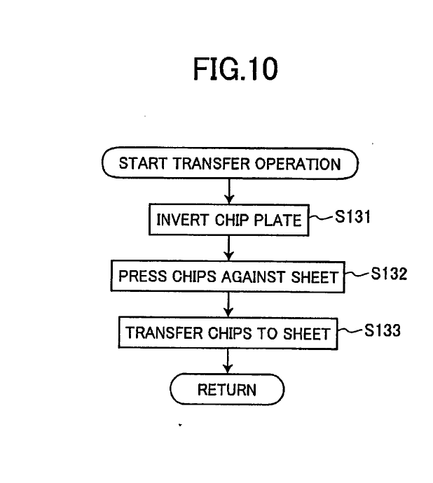

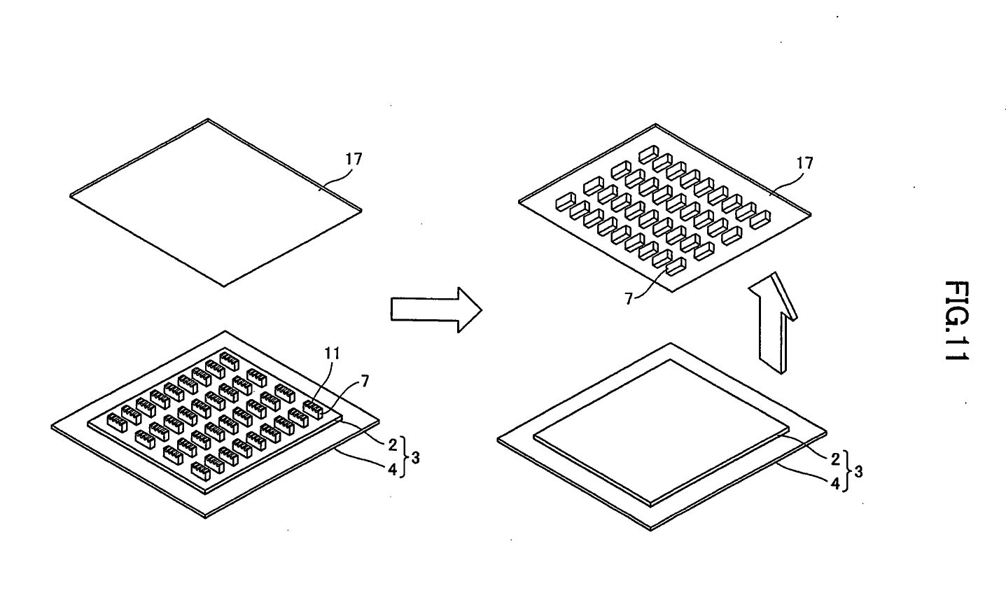

After completing the first drying step in S104 completing formation of the first electrodes 11 on the chips 7, in S105 the chips 7 are transferred to a sheet 17. This transfer process is described in greater detail in the flowchart of FIG. 10. In S131, the plate 3 holding the chips 7 is first inverted in the sixth position and moved to the seventh position, as shown in FIGS. 1 and 9(a). At this time, the second conveyor supplies a sheet 17 from the sheet supplying magazine 19 to the seventh position.

In S132 the sheet 17 and the plate 3 holding the chips 7 are brought into relative proximity of each other in a parallel state at the seventh position as shown in FIG. 9(a), and the first electrode 11 side of the chips 7 is pressed against the sheet 17 until the chips 7 are held by the foamable and releasable adhesive 16 as shown in FIG. 9(b). Subsequently, in S133 the plate 3 and the sheet 17 are relatively moved away from each other as shown in FIG. 9(c). Since the foamable and releasable adhesive 16 has adhesive strength greater than that of the silicon rubber 2, the chips 7 are pulled away from the plate 3 and held by the sheet 17 so that the chips 7 are separated from the silicon rubber 2. Further, the foamable and releasable adhesive 16 has a jelly-like property that provides some elasticity, but will undergo plastic deformation if displaced with sufficient force and will maintain this new shape. Therefore, even if the first electrodes 11 differ in flatness for each chip 7, these differences will be canceled when the plate 3 and sheet 17 are pressed together, thereby positioning the first end faces 7a for all chips 7 substantially in the same plane.

More specifically, after the first electrodes 11 are formed on the chips 7, the silicon rubber 2 formed on the base plate 4 of the plate 3 holds the plurality of chips 7 prior to the transfer, as shown in FIG. 11. The sheet 17 is supplied directly above the plate 3, and the plate 3 and sheet 17 are brought together with pressure. Once the chips 7 are fixed to the sheet 17, the plate 3 and sheet 17 are separated, at which time the chips 7 are pulled away from the plate 3 by the foamable and releasable adhesive 16, which has a greater adhesive strength than the silicon rubber 2, and are held by the sheet 17.

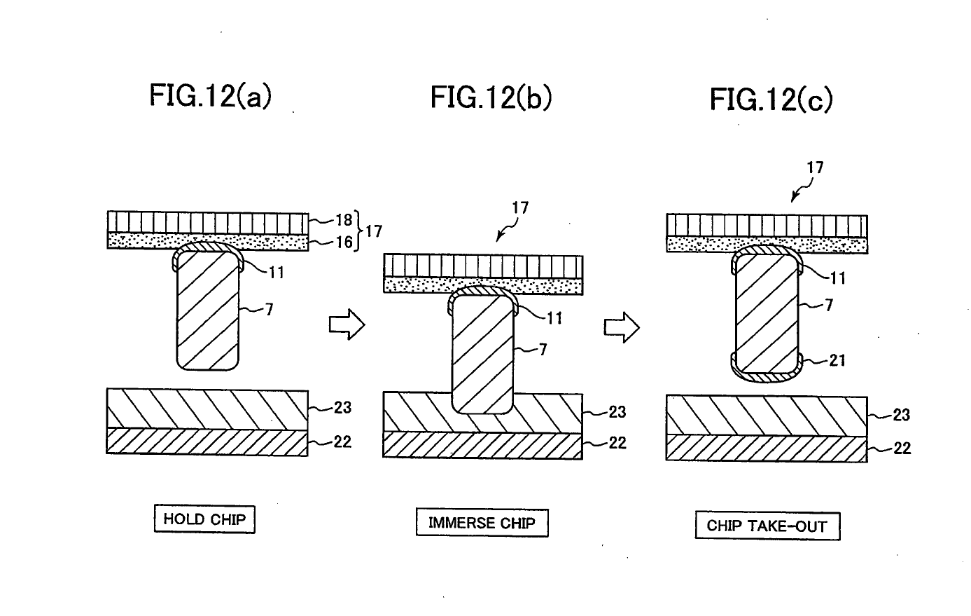

In S106, the sheet 17 is moved to the eighth position where the first end face 7a side of the chips 7 is coated with a second electrode. As shown in FIGS. 1 and 12(a), the coating bed 22 is positioned below the chip 7. As shown in FIG. 12(a), the chips 7 held by the sheet 17 and the electrically conductive paste 23 formed on the coating bed 22 are brought toward each other so that the first end faces 7a of the chips 7 are pressed against the coating bed 22, which has a high degree of flatness, thereby immersing the chips 7 in the conductive paste 23 to a prescribed depth on the first end face 7a side as shown in FIG. 12(b). Subsequently, the sheet 17 and coating bed 22 are separated from each other, removing the chips 7 from the conductive paste 23 but leaving a coating of conductive paste on the first end face 7a side to form the second electrodes 21 as shown in FIG. 12(c). Since the first end faces 7a of all chips 7 held by the sheet 17 are positioned substantially in the same plane, as described above, all of the chips 7 are immersed in the conductive paste 23 to substantially the same depth, thereby coating the first end faces 7a of the chips 7 with substantially the same amount of conductive paste.

In S107 the coated conductive paste is dried to form the second electrodes 21. This second drying step is performed while the sheet 17 is conveyed from the ninth position to the eleventh position. As shown in FIG. 1, drying is performed by direct heating using a halogen heater, or ambient heating. A halogen heater shown in FIG. 7 is used for the direct heating or radiation heating. Alternatively, while the ambient heating method is identical to the convection heating method shown in FIG. 8. Since the upper limit of the heat resistant temperature of the foamable and releasable adhesive 16 can be adjusted, as described above, it is necessary to set this upper limit and control the drying temperature, or to perform localized heating on only the conductive paste, so as to maintain adhesive strength during the second drying step.

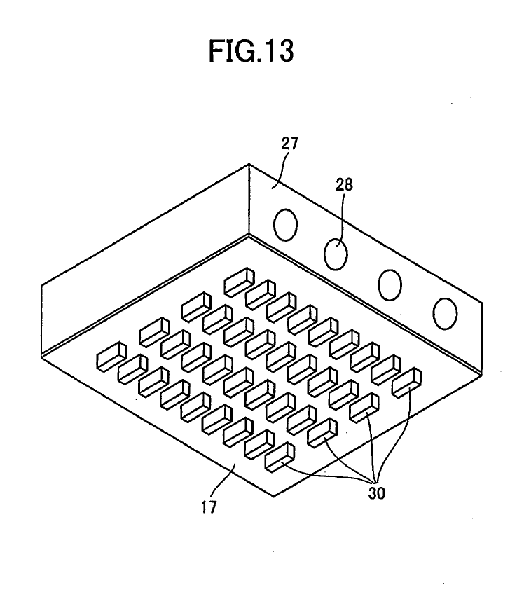

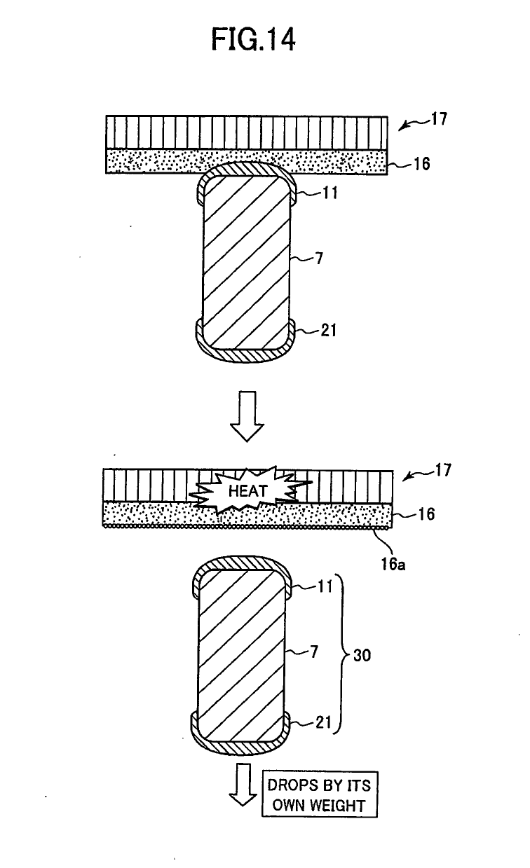

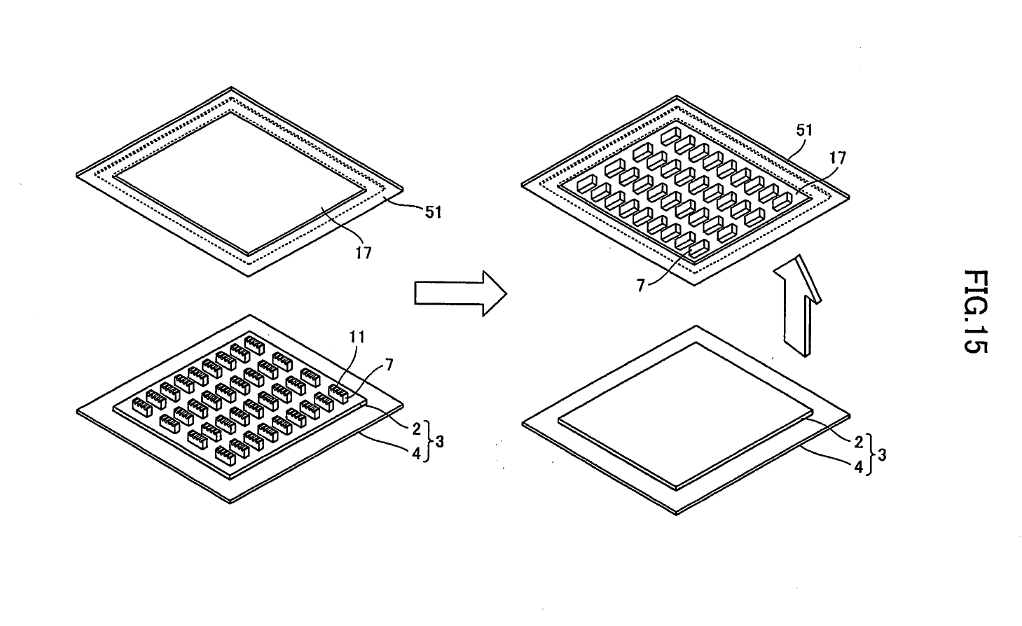

After forming the second electrodes 21, in S108 the sheet 17 is conveyed to the twelfth position for discharging the chips 7. As shown in FIG. 1, the hot plate (heater) 27 is provided directly above the sheet 17 in the twelfth position. As shown in FIG. 13, the hot plate 27 has a rectangular parallelepiped shape similar to the sheet 17 in a plan view. The hot plate 27 accommodates heaters 28. The sheet 17 is drawn by vacuum suction so that the PET film 18 side of the sheet 17 is in contact with the hot plate 27. At this time, the sheet 17 holds electronic components 30 with the first electrodes 11 and second electrodes 21 formed thereon, as shown in FIG. 14.

The heaters 28 heat the hot plate 27, which in turn heats the sheet 17. When the foamable and releasable adhesive 16 of the sheet 17 is heated to about 170° C., a surface 16a of the foamable and releasable adhesive 16 begins to foam. The foam reduces the contact surface area with the electronic component 30, causing the foamable and releasable adhesive 16 to lose its adhesive strength. As a result, the electronic components 30 separate from the sheet 17 and drop by their own weight, as shown in FIG. 14. The discharge box 29 formed with an open top is disposed directly beneath the sheet 17 in the twelfth position for recovering the electronic components 30. When the electronic components 30 is separated from the sheet 17, the sheet 17 is collected in the sheet recovering magazine 31, thus completing production of the electronic components 30.

With the method and device for forming external electrodes in an electronic chip component according to the first embodiment described above, the first electrode 11 is formed by applying the electrically conductive paste to the chips 7 held in the silicon rubber 2 of the plate 3 and subsequently drying the conductive paste. Next, the ends of the chips 7 on which the first electrodes 11 have been formed are pressed against and fixed to the foamable and releasable adhesive 16 provided in the sheet 17, which has a higher adhesive strength than the silicon rubber 2, allowing the sheet 17 to pull the chips 7 from the silicon rubber 2. The second electrodes 21 are then formed in the same way as the first electrodes 11, while the sheet 17 holds the chips 7. The electronic components 30 formed with the first and second electrodes 11, 21 separate and fall from the sheet 17 by their own weight when the foamable and releasable adhesive 16 is made to foam by heat, reducing the contact surface area and reducing the adhesive strength of the foamable and releasable adhesive 16.

Since the first adhesive member (silicon rubber 2) has a higher heat resistance than the second adhesive member (foamable releasable adhesive material 16), the drying temperature in the first drying step (S104) can be set higher than that in the second drying step (S107), thereby reducing drying time in the first drying step.

Further, since the first adhesive member has a lower adhesive strength than that of the second adhesive member, the chip element can be easily and reliably peeled from the first adhesive member with the second adhesive member fixed to the first external electrode side of the chip element. Furthermore, since the second adhesive member has a non-contact separating function without applying an external mechanical force, no damage is incurred by the chip element (electronic chip component) or any jig during separation.

When supplying the chips 7 to the plate 3 in the method and device described above for forming external electrodes in the electronic chip component, the chips 7 are first arrayed in the alignment block 40, then the plate 3 held in a state parallel to the alignment block 40 is brought near the same so that the chips 7 are pressed into and held by the silicon rubber 2. Since the alignment block 40 is fixed at this time, the plate 3 can grip the chips 7 with maintaining posture of the chips 7. Further, when forming the first electrodes 11 and second electrodes 21, the end faces of the chips 7 are coated with the conductive paste by pressing the chips 7 against the coating bed 10 and coating bed 22 having a high degree of flatness, thereby suppressing variations in the electrode forming regions. Thus, resultant electronic components can provide stabilized quality.

Further, when forming the second electrodes 21, the foamable and releasable adhesive 16 can undergo plastic deformation to cancel irregularities in the first electrode 11 side held by the sheet 17. Therefore, each of the first end faces 7a on which the second electrode 21 is to be formed can be adjusted to substantially the same plane. Accordingly, the electrode forming regions of the plurality of chips 7 held by the sheet 17 are made more uniform, producing electronic components 30 of a stable quality.

Since the upper temperature limit of the silicon rubber 2 is sufficiently high, the drying step during electrode formation can be performed without using localized heating to heat only the electrode. Therefore, compact device can result.

When transferring the chips 7 from the plate 3 to the sheet 17, the plate 3 is first inverted. In this way, the conveying directions of the plate 3 and the sheet 17 can be set opposite one another, enabling the entire device more compact.

Since application of external force to the electronic components 30 is not necessary when separating the electronic components 30 from the sheet 17, the electronic components 30 can be separated without damaging the second electrodes 21. Further, since the sheets 17 are disposable and require no cleaning, the electronic components 30 can be manufactured with high efficiency. The plates 3, on the other hand, are reusable. Hence, by using the plates 3, it is possible to minimize the disposable amount, thereby minimizing the amount of subsidiary materials required for manufacturing the electronic chip components.

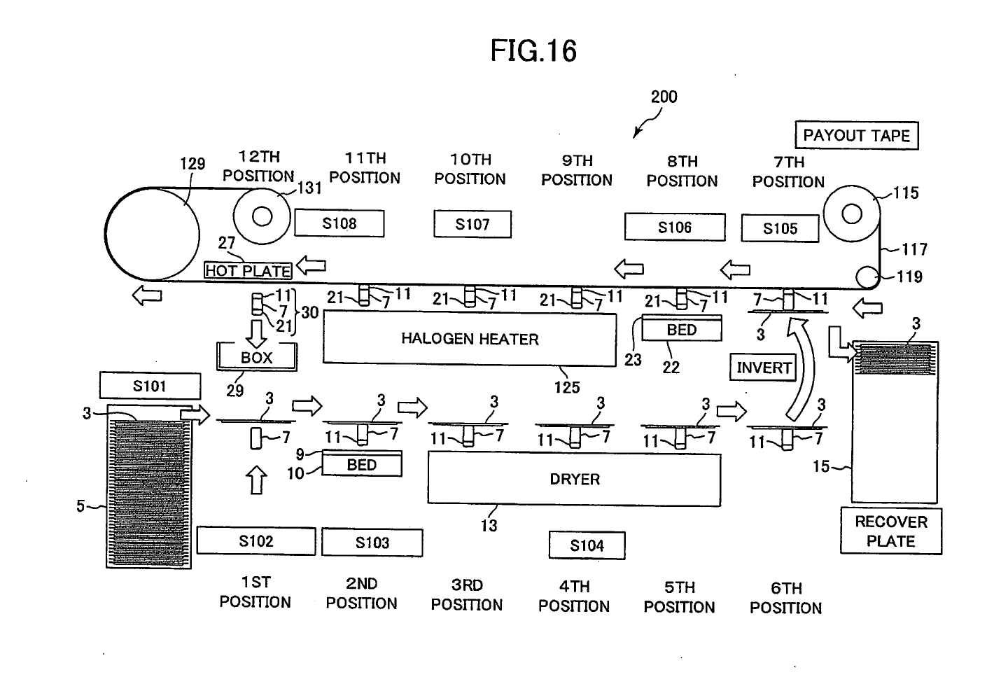

Next, a method and device for forming external electrodes in an electronic chip component according to a second embodiment of the present invention will be described with reference to FIG. 16. In FIG. 16, like parts and components are designated by the same reference numerals as those shown in FIGS. 1 through 15 to avoid duplicating description.

FIG. 16 shows an external electrode forming device 200 according to the second embodiment that employs a different structure and conveying method for the second adhesive member. The second adhesive member is configured of an adhesive tape 117 coated on one surface with a foamable and releasable adhesive material. The adhesive tape 117 is conveyed intermittently at prescribed intervals by a tape feeding mechanism including a payout roll 115, a drive roll 129, and a take-up roll 131. The adhesive tape 117 is initially wound around the payout roll 115, and is paid out from the payout roll 115, runs from the seventh position to the twelfth position in the external electrode forming device 200, and is taken up on the take-up roll 131. The drive roll 129 grips a non-adhesive surface of the adhesive tape 117 by vacuum suction and angularly rotates intermittently at fixed intervals and by a fixed angle of rotation so as to convey the adhesive tape 117 a fixed amount.

Due to the positioning of the rolls, an additional guide roll 119 is disposed between the payout roll 115 and 129 along the adhesive tape 117 for adjusting the conveying passage of the adhesive tape 117. The adhesive tape 117 can be a thermal release tape, such as the product “REVALPHA” manufactured by Nitto Denko Corporation. The adhesive strength of the adhesive tape 117 should be greater than that of the silicon rubber 2.

Next, operation of the external electrode forming device 200 will be described. The following description pertains to the difference in operation of the external electrode forming device 1 of the first embodiment. In the second embodiment, the process performed from the first position to the sixth position is identical to that in the first embodiment. For simplicity, only a single chip 7 is shown in FIG. 16, but in fact a plurality of chips 7 are arranged two-dimensionally on a single plate 3, as described in the first embodiment.

In the sixth position, after forming the first electrodes 11 on the second end faces 7b of the chips 7, the plate 3 holding the plurality of chips 7 is inverted. The plate 3 is held in a state parallel to the adhesive tape 117 and brought near the same in the seventh position so that the chips 7 are pressed against the adhesive tape 117. After the foamable and releasable adhesive formed on the adhesive tape 117 grips the chips 7 still held by the plate 3, the plate 3 is relatively moved away from the adhesive tape 117. Since the adhesive tape 117 holding the chips 7 has a stronger adhesive strength than the plate 3, the chips 7 are pulled and separated from the plate 3.

Next, the drive roll 129 is rotated a prescribed angle, moving the adhesive tape 117 a prescribed distance for transferring the chips 7 to the eighth position. In the eighth position, the coating bed 22 with the electrically conductive paste 23 is disposed directly below the chips 7. The chips 7 held by the adhesive tape 117 and the conductive paste 23 are brought together so that the first end faces 7a of the chips 7 are pressed against the coating bed 22, which is formed with a high degree of flatness, thereby immersing the chips 7 in the conductive paste 23 to a prescribed depth on the first end face 7a side. Subsequently, the adhesive tape 117 and coating bed 22 are relatively moved away from each other, removing the chips 7 from the conductive paste 23 but leaving a coating of conductive paste for forming the second electrodes 21. Since the foamable and releasable adhesive 116 has undergone plastic deformation, the first end faces 7a of all chips 7 held in the adhesive tape 117 are disposed in substantially the same plane, as described in the first embodiment. Therefore, all chips 7 are immersed in the conductive paste 23 to substantially the same depth, coating the first end faces 7a with substantially the same amount of conductive paste.

The second drying step is then performed to dry the conductive paste forming the second electrodes 21. This step is implemented while the adhesive tape 117 moves intermittently from the ninth position to the eleventh position and is achieved through direct heating with a halogen heater 125. In this second drying step, it is preferable to control the drying temperature so that the foamable and releasable adhesive 116 does not lose its adhesive strength, and to perform localized heating on only the conductive paste.

After the second electrodes 21 are formed, the drive roll 129 is again rotated a prescribed angle to convey the adhesive tape 117 to the twelfth position. In the twelfth position, the hot plate 27 is disposed directly above the adhesive tape 117. The hot plate 27 draws the non-adhesive side of the adhesive tape 117 with using vacuum suction and begins heating the adhesive tape 117. When the foamable and releasable adhesive 116 of the adhesive tape 117 is heated to about 170° C., the surface of the foamable and releasable adhesive 116 begins to foam, reducing the contact surface area and causing the foamable and releasable adhesive 116 to lose adhesive strength. As a result, the electronic components 30 separate and drop from the adhesive tape 117 by their own weight. The open-top discharge box 29 is disposed directly under the adhesive tape 117 in the twelfth position for collecting the electronic components 30. Each time the drive roll 129 rotates a prescribed angle during this operation, a prescribed length of the adhesive tape 117 is paid out from the payout roll 115 and a similar prescribed length is taken up on the take-up roll 131. Hence, a substantially uniform tension can be constantly maintained in the adhesive tape 117, enabling the chips 7 to be held with stability. With the process described above, the electronic components 30 are successively produced.

With the external electrode forming device 200 according to the second embodiment, the first electrodes 11 are first formed on the chips 7 while the silicon rubber 2 holds the chips 7, and the second electrodes 21 are subsequently formed using the adhesive tape 117. Since the adhesive tape 117 has a greater adhesive strength than the silicon rubber 2, the chips 7 can be reliably transferred from the plate 3 to the adhesive tape 117. Further, since the first electrodes and second electrodes are formed substantially uniform, stable properties can be obtained in the resulting electronic components.

Further, after forming the first electrodes 11 and second electrodes 21 on the chips 7, the foamable and releasable adhesive 116 loses its adhesive strength by heating the adhesive tape 117, allowing the electronic components 30 to separate from the adhesive tape 117 without application of external force.

While the present invention has been described in detail with reference to specific embodiments thereof, it would be apparent to those skilled in the art that various modifications may be made therein without departing from the scope of the invention, the scope of which is defined by the attached claims.

For example, the sheet 17 described in the first embodiment is a sheet configured of the PET film 18 coated with the foamable and releasable adhesive 16. However, instead of the sheet 17, a base plate 51 made from a stainless steel shown in FIG. 15 and formed with the sheet 17 on the base plate 51 can be used. This construction can ensure the strength of the sheet. The remaining structure of the external electrode forming device and the method for forming external electrodes is identical to that described in the first embodiment.

While the preferred embodiments describe a method of forming external electrodes on chips 7 having a rectangular parallelepiped shape, the same method is available for differently configured chips such as cylindrical chips or a polygonal chips as long as these chips have two opposing end faces.

While a foamable and releasable adhesive is used as the adhesive material for the sheet 17 and adhesive tape 117, any material having a non-contact release function can be used. For example, it is possible to use a UV release adhesive that loses adhesive strength when exposed to radiation of ultraviolet light or a water-sensitive adhesive that loss adhesive strength when immersed in water.

Further, the method of arraying the chips 7 on the plate 3 is not limited to use of the alignment block 40 described in the embodiments. Further, arraying pattern of the chips 7 is not limited to the above-described embodiment.

Further, while a hot plate is used to heat the foamable and releasable adhesive material in the preferred embodiments described above, another heater is available such as a localized halogen lamp for supplying heat to a concentrated prescribed region.

What is claimed is:

1. A method for forming external electrodes on a chip element having a first end face and a second end face on opposing ends to produce an electronic chip component, the method comprising:
a first fixing step for fixing the first end face to a first adhesive member;
a first electrode applying step for applying an electrode material to the second end face of while the chip element is fixed to the first adhesive member;
a first drying step for drying the electrode material applied in the first electrode applying step to produce a first external electrode;
a second fixing step for transferring the chip element from the first adhesive member to a second adhesive member and fixing the first external electrode side of the chip element to the second adhesive member;
a second electrode applying step for applying an electrode material to the first end face while the chip element is fixed to the second adhesive member;
a second drying step for drying the electrode material applied in the second electrode applying step to produce a second external electrode; and
a separating step for separating the chip element from the second adhesive member without application of external mechanical force to the chip element.

2. The method as claimed in claim 1, wherein the second adhesive member has an upper temperature limit lower than that of the first adhesive member.

3. The method as claimed in claim 1, wherein the second adhesive member has an adhesive power stronger than that of the first adhesive member in the second fixing step.

4. The method as claimed in claim 3, wherein in the second fixing step, the chip element is transferred from the first adhesive member to the second adhesive member by pulling the chip element away from the first adhesive member while the first electrode is in adhesive contact with the second adhesive member.

5. The method as claimed in claim 1, wherein the second adhesive member is formed of a thermally foamable adhesive agent.

6. The method as claimed in claim 5, wherein the second adhesive member reduces its adhesive power upon foaming of the adhesive member by heat application during the separation step.

7. The method as claimed in claim 1, wherein the second adhesive member is made from a material plastically deformable in the second fixing step.

8. A device for forming external electrodes on a chip element having a first end face and a second end face on opposing ends to produce an electronic chip component, the device comprising:
a first conveying unit provided with a first adhesive member;
a first fixing unit configured to fix the first end face to the first adhesive member;
a first electrode applying unit configured to apply an electrode material onto the second end face while the first end face is fixed to the first adhesive member;
a first drying unit configured to dry the electrode material formed on the second end face to produce a first external electrode;
a second conveying unit provided with a second adhesive member;
a second fixing unit configured to transfer the chip elements from the first adhesive member to the second adhesive member and fix the first external electrode side of the chip element to the second adhesive member;
a second electrode applying unit configured to apply an electrode material to the first end face while the chip element is fixed to the second adhesive member;
a second drying unit configured to dry the electrode material applied in the second electrode to produce a second external electrode; and
a separating unit configured to separate the chip element from the second adhesive member without application of external mechanical force to the chip element.

9. The device as claimed in claim 8, wherein the second adhesive member has an upper temperature limit lower than that of the first adhesive member.

10. The device as claimed in claim 8, wherein the second adhesive member has an adhesive power stronger than that of the first adhesive member at the second fixing unit.

11. The device as claimed in claim 10, wherein the second fixing unit comprises a pulling unit that pulls the chip element away from the first adhesive member while the first electrode is in adhesive contact with the second adhesive member for transferring the chip element from the first adhesive member to the second adhesive member.

12. The device as claimed in claim 8, wherein the second adhesive member is formed of a thermally foamable adhesive agent.

13. The device as claimed in claim 12, wherein the separating unit comprises a heater, and
wherein the second adhesive member is made from a material capable of reducing its adhesive power upon foaming of the adhesive member by heat application by the heater.

14. The device as claimed in claim 8, wherein the second adhesive member is made from a material plastically deformable in the second fixing unit.
